(19) United States
(12) Patent Application Publication
(10) Pub. No.: US 2026/0246504 A1
(43) Pub. Date: Aug. 20, 2026

(54) TECHNIQUES FOR PRECODING UPLINK MULTI-USER MULTIPLE INPUT MULTIPLE OUTPUT COMMUNICATIONS

(71) Applicant: QUALCOMM Incorporated, San Diego, GA (US)

(72) Inventors: Chih-Hao LIU, San Diego, CA (US); Jing SUN, San Diego, CA (US); Yu ZHANG, San Diego, CA (US); Jing JIANG, San Diego, CA (US)

(21) Appl. No.: 19/058,196

(22) Filed: Feb. 20, 2025

(51) Int. Cl. H04B 7/0452; H04B 7/0456; H04W 72/232

(52) U.S. Cl. CPC H04B 7/0452; H04B 7/0456; H04W 72/232

(57) ABSTRACT

Various aspects of the present disclosure generally relate to wireless communication. In some aspects, a user equipment (UE) may receive an indication of an uplink precoder for an uplink multi-user multiple input multiple output (MU-MIMO) communication that is associated with the UE and one or more other UEs. The UE may transmit an uplink transmission associated with the uplink MU-MIMO communication based at least in part on using the uplink precoder. Numerous other aspects are described.

### FIELD OF THE DISCLOSURE

Aspects of the present disclosure generally relate to wireless communication and specifically relate to techniques, apparatuses, and methods associated with precoding uplink multi-user multiple input multiple output communications.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, various devices may communication using a multi-user multiple input multiple output (MU-MIMO) scheme. For example, a network node may perform MU-MIMO communication with multiple users, such as a first user equipment (UE) and a second UE. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO).

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving an indication of an uplink precoder for an uplink multi-user multiple input multiple output (MU-MIMO) communication that is associated with the UE and one or more other UEs. The method may include transmitting an uplink transmission associated with the uplink MU-MIMO communication based at least in part on using the uplink precoder.

Some aspects described herein relate to a method of wireless communication performed by a network node. The method may include transmitting, to a UE, an indication of an uplink precoder for an uplink MU-MIMO communication that is associated with the UE and one or more other UEs. The method may include receiving, from the UE, an uplink transmission associated with the uplink MU-MIMO communication that is based at least in part on the uplink precoder.

Some aspects described herein relate to a UE. The UE may include one or more memories and one or more processors coupled to the one or more memories. The one or more processors may be individually or collectively configured to receive an indication of an uplink precoder for an uplink MU-MIMO communication that is associated with the UE and one or more other UEs. The one or more processors may be individually or collectively configured to transmit an uplink transmission associated with the uplink MU-MIMO communication based at least in part on using the uplink precoder.

Some aspects described herein relate to a network node. The network node may include one or more memories and one or more processors coupled to the one or more memories. The one or more processors may be individually or collectively configured to transmit, to a UE, an indication of an uplink precoder for an uplink MU-MIMO communication that is associated with the UE and one or more other UEs. The one or more processors may be individually or collectively configured to receive, from the UE, an uplink transmission associated with the uplink MU-MIMO communication that is based at least in part on the uplink precoder.

Some aspects described herein relate to a non-transitory computer-readable medium that stores a set of instructions for wireless communication by a UE. The set of instructions, when executed by one or more processors of the UE, may cause the UE to receive an indication of an uplink precoder for an uplink MU-MIMO communication that is associated with the UE and one or more other UEs. The set of instructions, when executed by one or more processors of the UE, may cause the UE to transmit an uplink transmission associated with the uplink MU-MIMO communication based at least in part on using the uplink precoder.

Some aspects described herein relate to a non-transitory computer-readable medium that stores a set of instructions for wireless communication by a network node. The set of instructions, when executed by one or more processors of the network node, may cause the network node to transmit, to a UE, an indication of an uplink precoder for an uplink MU-MIMO communication that is associated with the UE and one or more other UEs. The set of instructions, when executed by one or more processors of the network node, may cause the network node to receive, from the UE, an uplink transmission associated with the uplink MU-MIMO communication that is based at least in part on the uplink precoder.

Some aspects described herein relate to an apparatus for wireless communication. The apparatus may include means for receiving an indication of an uplink precoder for an uplink MU-MIMO communication that is associated with the apparatus. The apparatus may include means for transmitting an uplink transmission associated with the uplink MU-MIMO communication based at least in part on using the uplink precoder.

Some aspects described herein relate to an apparatus for wireless communication. The apparatus may include means for transmitting, to a UE, an indication of an uplink precoder for an uplink MU-MIMO communication that is associated with the UE and one or more other UEs. The apparatus may include means for receiving, from the UE, an uplink transmission associated with the uplink MU-MIMO communication that is based at least in part on the uplink precoder.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of physical channels and reference signals in a wireless network.

FIGS. 4A-4B are diagrams illustrating examples of wireless message precoding and demapping.

FIG. 5 is a diagram of an example associated with precoding uplink multi-user multiple input multiple output communications.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of another example apparatus for wireless communication.

### DETAILED DESCRIPTION

In some wireless communication systems, devices (e.g., user equipments (UEs) and network nodes) may communicate using multiple input multiple output (MIMO) communications. In some examples, a channel coding process used for the MIMO communications may be associated with singular value decomposition (SVD) precoding. SVD precoding may decompose a channel matrix into a set of components that includes a first unitary matrix representing transmitter spatial directions, a diagonal matrix that includes values associated with channel gain for each spatial layer, and a second unitary matrix associated with receiver spatial directions. The SVD decomposition may enable the transmitter to precode data streams in alignment with a set of eigenmodes associated with a channel used for transmission. In some examples, aligning the precoded data streams with the set of eigenmodes may respectively increase the signal-to-noise ratio (SNR) across the set of spatial layers, which may result in a different SNR associated with each spatial layer, resulting in a reduction in quality for certain MIMO communications. For example, decoding at the receiver may be relative to a spatial layer associated with the lowest SNR. In other words, decoding performance at the receiver may be limited by the lowest SNR across a set of MIMO spatial layers.

Accordingly, in some other examples, a channel coding process for a MIMO communication may be associated with a precoding procedure that enables equalizing signal quality across a set of MIMO spatial layers. For example, the transmitter may use a precoder associated with balancing SNR across the set of MIMO spatial layers. In some examples, the precoder may be associated with geometric mean decomposition (GMD) precoding, such as a zero-forcing GMD precoder, among other examples. In such examples, a GMD transceiver may transform the system into M independent scalar Gaussian channels with a same SNR, and thus the receiver may be associated with a demapper that achieves a channel capacity with the same modulation and coding scheme (MCS) on each stream without a need for multiple transport blocks (TBs), among other examples.

Some MIMO communications may be associated with multi-user MIMO (MU-MIMO) communications, such as uplink MU-MIMO communications in which multiple UEs transmit uplink transmissions to a network node, with each UE's respective transmission forming a corresponding spatial layer of the uplink MU-MIMO communication. In some examples of uplink MU-MIMO, the cross-layers interference among the UEs may cause communication errors. Accordingly, in some examples, a demapper at a network node may perform a joint modulation for all layers across spatial domain multiplexed (SDMed) UEs in order to enable successive cancellation of interference from the different UEs and layers, thus improving communication performance. However, it may not be possible to utilize GMD precoding at each UE associated with an uplink MU-MIMO communication (e.g., to achieve equal SNR across layers) while enabling the network node to perform joint demapping to cancel inter-UE and inter-layers interference, because per-UE GMD may only be able to achieve per-UE decoding and thus may not guarantee inter-UE interference cancellation without joint demodulation.

Accordingly, in some examples, it may be beneficial to employ block diagonal GMD (BD-GMD) for uplink transmissions, such as for uplink MU-MIMO communications, which may enable equalized SNR across layers of an uplink MU-MIMO communication while enabling the network node to perform joint demapping to cancel inter-UE and inter-layers interference. However, current wireless communication systems may not support BD-GMD-based uplink MU-MIMO communications. This is because a UE associated with an uplink MU-MIMO communication may not be aware of channels of the other UEs associated with the uplink MU-MIMO communication. Accordingly, the UEs may be unable to determine a respective precoder for the uplink MU-MIMO communication to successfully implement BD-GMD-based demapping, among other examples. As a result, wireless communication systems may forgo uplink MU-MIMO communications altogether (e.g., to avoid communication errors caused by cross-layer interference among the UEs), resulting in inefficient usage of network resources and thus high latency and low throughput. On the other hand, for wireless communication systems employing uplink MU-MIMO communications, the uplink MU-MIMO communications may result in a high incidence of cross-layer interference, leading to communication errors and thus high computing, power, and network resource consumption for correcting communication errors.

Various aspects relate generally to precoding uplink MU-MIMO communications. Some aspects more specifically relate to signaling of uplink precoders associated with uplink MU-MIMO communications. In some aspects, a network node may transmit, and a UE may receive, an indication of an uplink precoder for an uplink MU-MIMO communication that is associated with the UE and one or more other UEs. Additionally, or alternatively, the UE may transmit, and the network node may receive, an uplink transmission associated with the uplink MU-MIMO communication based at least in part on using the uplink precoder.

Particular aspects of the subject matter described in this disclosure can be implemented to realize one or more of the following potential advantages. In some examples, the described techniques can be used to enable multiple UEs to communicate in the uplink using MU-MIMO communications and thus overlapping transmissions in the time or frequency domain, thereby reducing latency, increasing throughput, and otherwise resulting in more efficient usage of network resources. Moreover, by the network node signaling the uplink precoders associated with the MU-MIMO communication to various UEs, the network node may equalize or balance SNRs across the spatial layers of the uplink MU-MIMO communication, which may increase the data rate of an equivalent uplink channel relative to the Shannon capacity of the uplink channel (e.g., the theoretical maximum data rate that the channel may achieve), thus resulting in more efficient usage of network resources or reduced communication errors and thus conservation of computing, power, network, and/or communication resources that may have otherwise been consumed to detect and/or correct communication errors.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

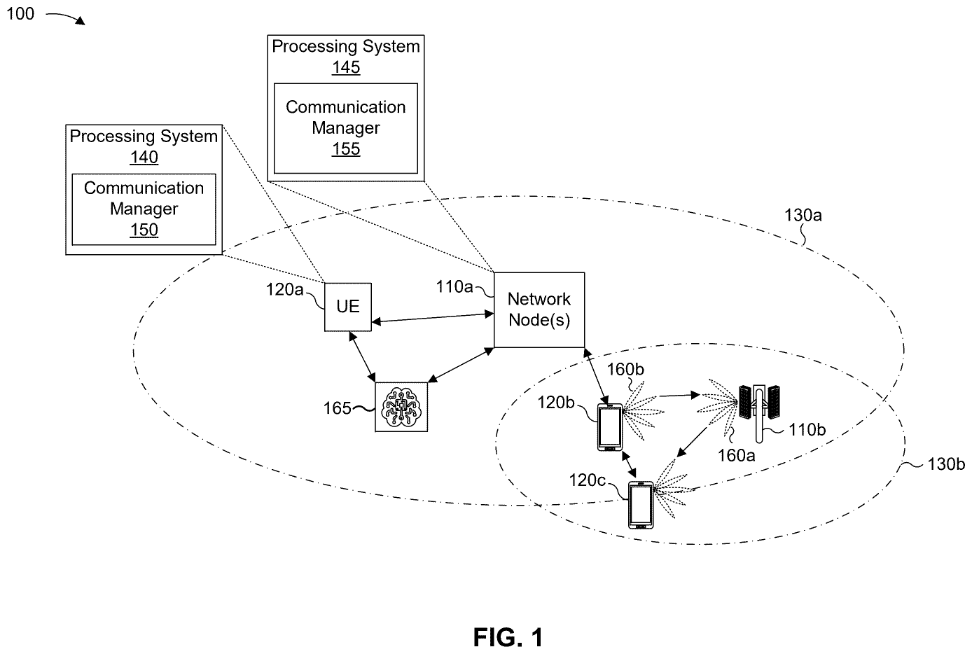

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHZ through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary synchronization signal (SSS), a synchronization signal block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), a synchronization signal/PBCH (SS/PBCH) resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or MU-MIMO, the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In the wireless communication network 100, information may be represented as a sequence of binary bits that are mapped (for example, modulated) to an analog signal waveform that is transmitted to a receiver over a wireless communication channel. In some cases, however, the wireless communication channel may introduce errors that corrupt the transmitted signal due to random noise, interference, device impairments, or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or forward error correction (FEC) techniques are often used to control errors in data transmission over unreliable or noisy communication channels or otherwise mitigate the bit errors that may occur due to noise, interference, or other factors. For example, channel coding generally includes an encoding operation performed at a transmitter (for example, a first wireless device, which may be a UE 120 or a network node 110) and a decoding operation performed at a receiver (for example, a second wireless device, which may be a UE 120 or a network node 110). Channel coding is generally accomplished by selectively introducing redundancy into the transmitted information stream, typically using an error correction code (ECC), which allows the receiver to detect errors or correct bit errors in the received data stream and thereby provide more reliable information transmission. Accordingly, channel codes are often used in scenarios where retransmissions are undesirable or high transmission reliability is needed, such as downlink or uplink control channel communications.

For example, in some cases, the wireless communication network 100 may use polar codes to implement channel coding for downlink or uplink control channel communications. More particularly, polar coding is a linear block coding technique that has provable capacity-achieving performance over binary channels with polynomial complexity in various scenarios (such as channel coding, among others). Polar coding has a built-in channel polarization structure that uses a recursive construction to split (or “polarize”) a communication channel into reliable subchannels that are very good for transmitting information and unreliable subchannels that are very bad for transmitting information. The reliable subchannels may be almost completely noiseless, with a capacity that approaches 1, and the unreliable subchannels may be almost completely noisy, with a capacity that approaches 0. During polar encoding, a polar transform is applied to assign information bits to the reliable subchannels and to assign “frozen” or “fixed” bits (for example, “0” bits) to the unreliable subchannels. For example, a polar code with a rate R=K/N may be defined according to a set of parameters {N, K, G_{N}, A}, where N is a code block length with N=2ⁿ, for n≥1, K is a code dimension, A is a data index set, A⊂{1, 2, . . . , N} with size |A|=K, and G_{N} is a polar transform defined by:

$${G}_{2} = [ \begin{matrix}1 & 0 \\ 1 & 1\end{matrix} ] , {G}_{N} = [ \begin{matrix}{G}_{N / 2} & 0 \\ {G}_{N / 2} & {G}_{N / 2}\end{matrix} ] = {G}_{2}^{⊗ n}$$

Given a data block d=(d₁, . . . , d_{K}), a polar code with the parameters {N, K, G_{N}, A} encodes the data block d in two steps, where the first step is to construct a transform input block u=(u₁, . . . , u_{N}) by setting:

$${u}_{A} \hat{=} ( {u}_{i} : i ∈ A ) = d , {u}_{A} c \hat{=} Δ ( {u}_{i} : i ∈ {A}^{C} ) = 0$$

and the second step is to compute the code block x by computing the polar transform of u, where x=uG_{N}. Accordingly, polar codes have an encoding/decoding complexity given by N log N, a construction complexity that is roughly O(N), and a block error probability that approaches zero roughly as 2^{-\sqrt{N}} for any fixed rate R that is less than a channel capacity (for example, there is no error floor).

In some aspects, the UE 120 may include a communication manager 150. As described in more detail elsewhere herein, the communication manager 150 may receive an indication of an uplink precoder for an uplink MU-MIMO communication that is associated with the UE 120 and one or more other UEs; and transmit an uplink transmission associated with the uplink MU-MIMO communication based at least in part on using the uplink precoder. Additionally, or alternatively, the communication manager 150 may perform one or more other operations described herein.

In some aspects, the network node 110 may include a communication manager 155. As described in more detail elsewhere herein, the communication manager 155 may transmit, to a UE, an indication of an uplink precoder for an uplink MU-MIMO communication that is associated with the UE and one or more other UEs; and receive, from the UE, an uplink transmission associated with the uplink MU-MIMO communication that is based at least in part on the uplink precoder. Additionally, or alternatively, the communication manager 155 may perform one or more other operations described herein.

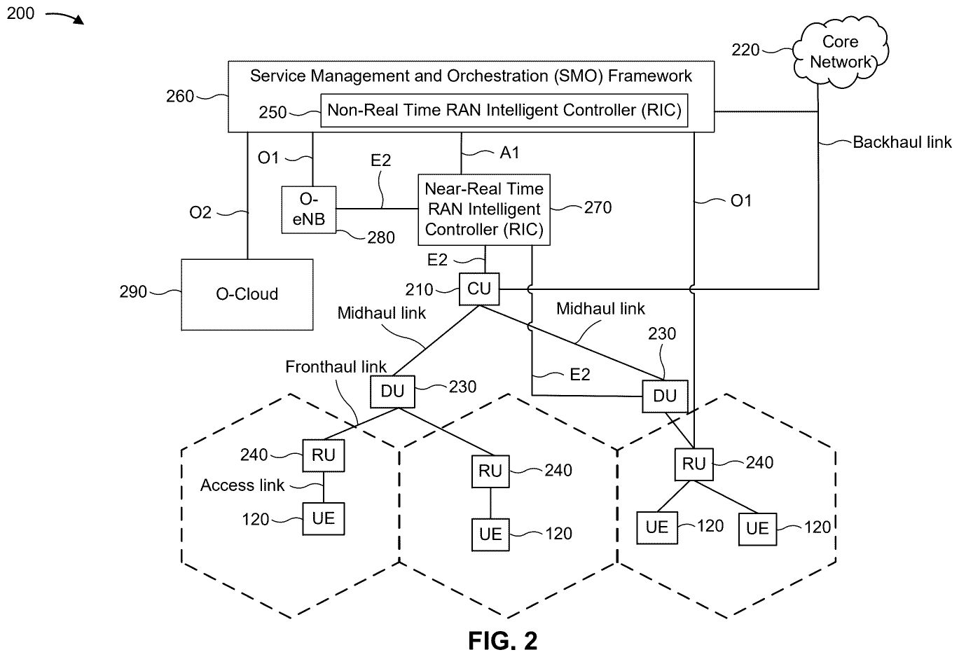

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

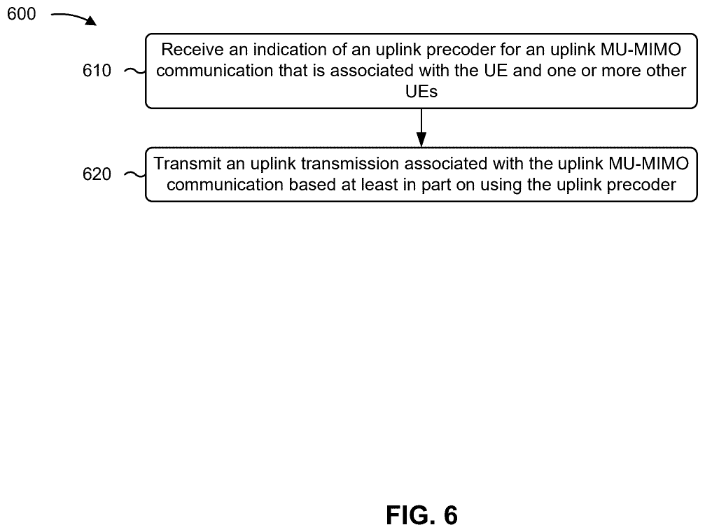

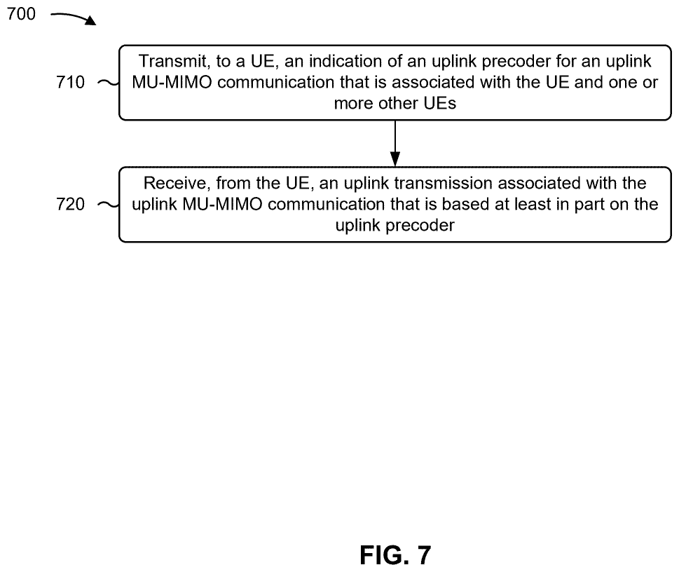

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with precoding uplink MU-MIMO communications, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

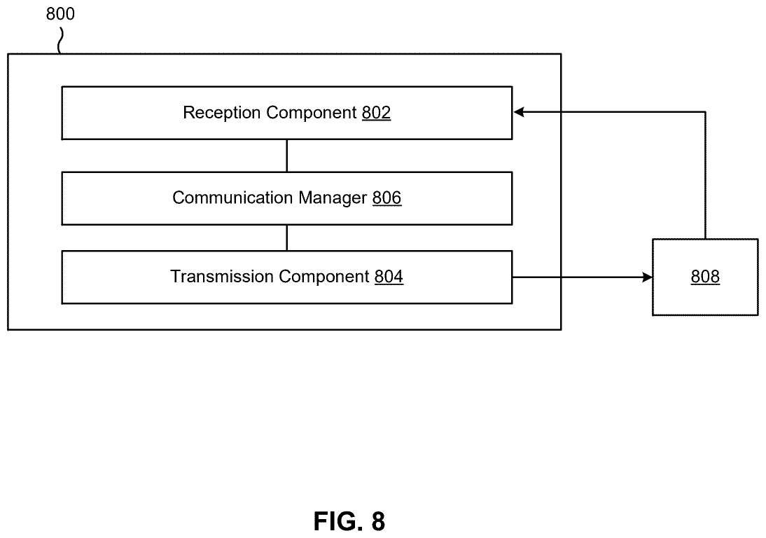

In some aspects, the UE 120 includes means for receiving an indication of an uplink precoder for an uplink MU-MIMO communication that is associated with the UE 120 and one or more other UEs; and/or means for transmitting an uplink transmission associated with the uplink MU-MIMO communication based at least in part on using the uplink precoder. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

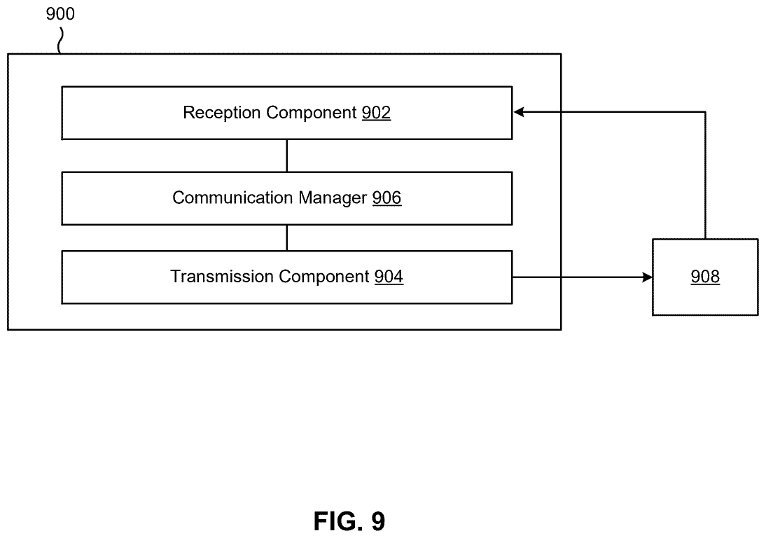

In some aspects, the network node 110 includes means for transmitting, to a UE, an indication of an uplink precoder for an uplink MU-MIMO communication that is associated with the UE and one or more other UEs; and/or means for receiving, from the UE, an uplink transmission associated with the uplink MU-MIMO communication that is based at least in part on the uplink precoder. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

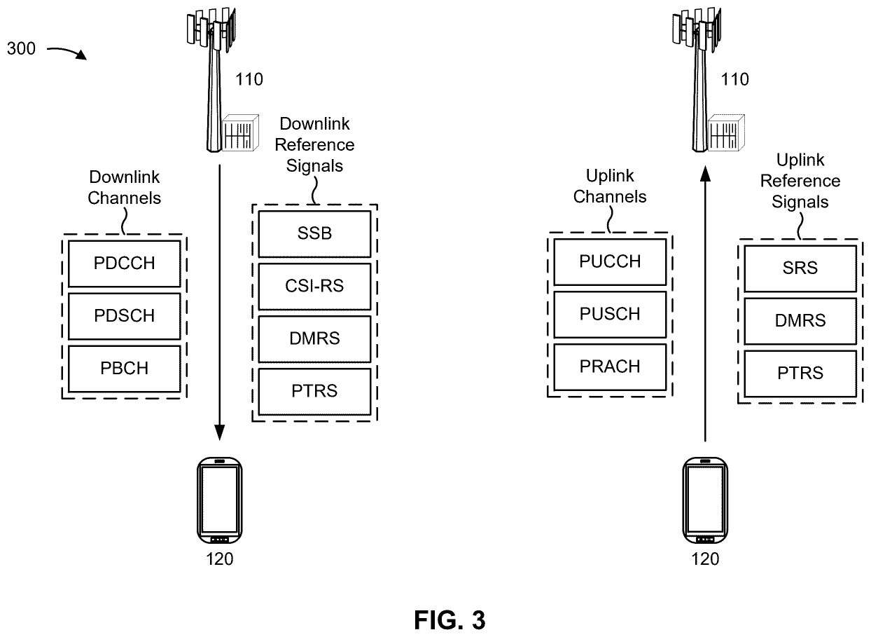

FIG. 3 is a diagram illustrating an example 300 of physical channels and reference signals in a wireless network. As shown in FIG. 3, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a PBCH that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH or the PUSCH.

As further shown, a downlink reference signal may include an SSB, a CSI-RS, a DMRS, a positioning reference signal (PRS), or a PTRS, among other examples. As also shown, an uplink reference signal may include a SRS, a DMRS, or a PTRS, among other examples.

An SSB may carry information used for initial network acquisition and synchronization, such as a PSS, an SSS, a PBCH, and a PBCH DMRS. An SSB is sometimes referred to as an SS/PBCH block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, an LI, an RI, or an RSRP, among other examples. The network node 110 may use the CSI report to select transmission parameters for downlink communications to the UE 120, such as a number of transmission layers (e.g., a rank), a precoding matrix (e.g., a precoder), a MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

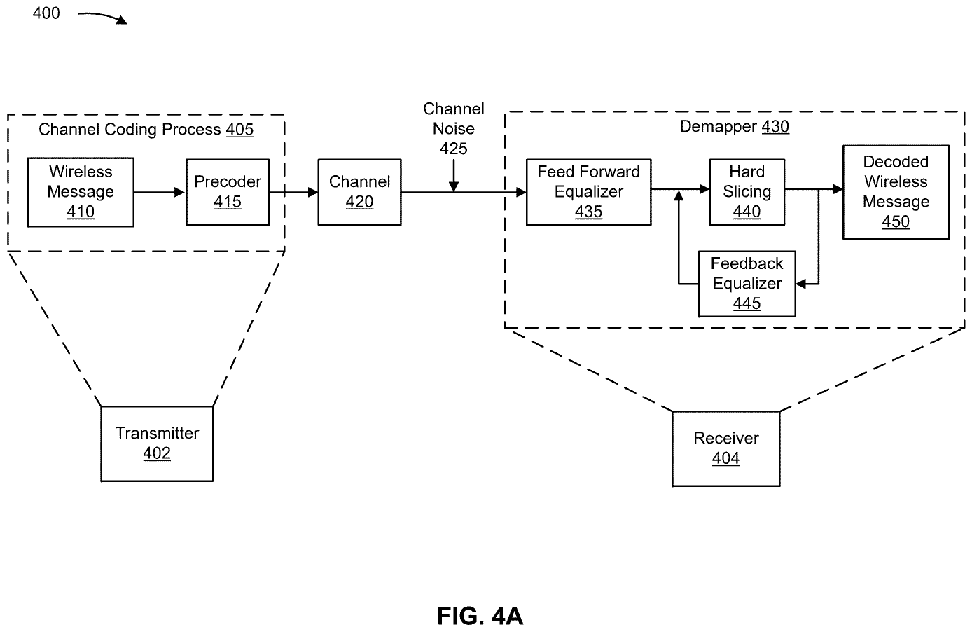

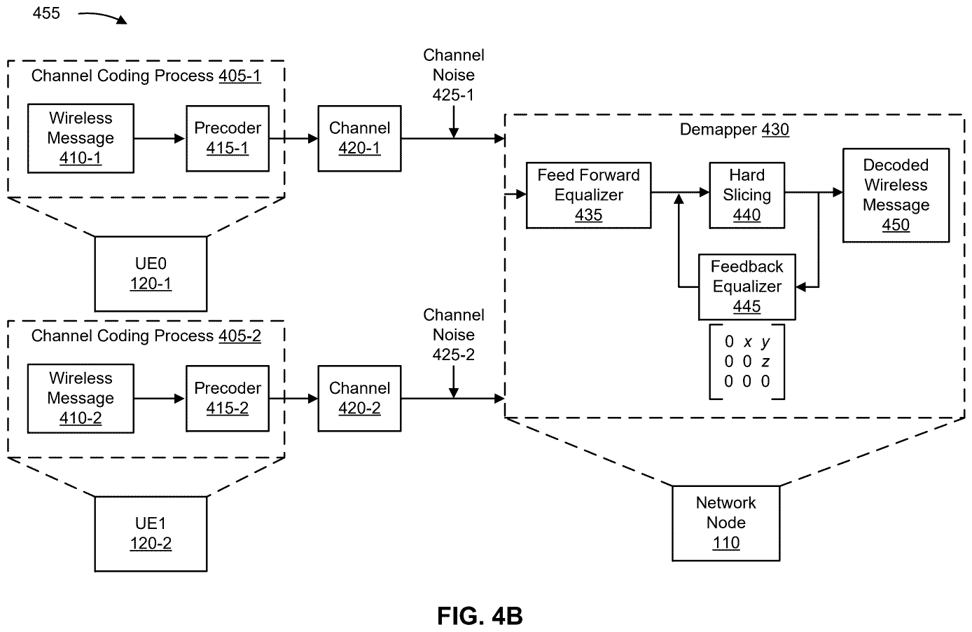

FIGS. 4A-4B are diagrams illustrating examples of wireless message precoding and demapping. In some wireless communication networks (e.g., wireless communication network 100), wireless communication devices (e.g., UEs 120, network nodes 110, or similar devices) may communicate using zero-forcing GMD precoding and demapping. For example, as shown in FIG. 4A, and by example 400, wireless communication devices may include a transmitter 402 (e.g., one of a UE 120 or a network node 110) and a receiver 404 (e.g., another one of a UE 120 or a network node 110).

In some examples, aspects of example 400 may support and/or be associated with MIMO precoding. For example, MIMO precoding may be categorized into codebook-based and non-codebook-based approaches. In some examples, codebook-based precoding may be associated with a predefined and/or preconfigured set of precoding matrices, or “codebooks” (e.g., defined in a wireless communications standard, such as 3GPP). In such examples, a network node 110 (which may, in some examples, correspond to the receiver 404) may select a precoding matrix from the set of precoding matrices based on feedback from a UE 120 (which may, in some examples, correspond to the transmitter 402). For instance, the UE 120 may transmit a CSI report that indicates a PMI, guiding the network node 110 in selecting the matrix that increases signal quality and reduces interference. Therefore, codebook-based MIMO precoding may increase computational efficiency at the network node 110 and the UE 120, and reduce signaling overhead based on leveraging the predefined set of precoding matrices. In contrast, non-codebook-based precoding may increase flexibility by enabling the network node 110 to compute precoding matrices dynamically, based on real-time CSI. Therefore, non-codebook-based precoding may provide an increased adaptability to diverse and evolving channel environments but may increase computational complexity and/or signaling overhead.

In some examples, the transmitter 402 may use one or more of codebook-based or non-codebook-based MIMO precoding to transmit a codeword. For example, a codeword may be an encoded representation of a wireless message 410 (e.g., a transport block). The codeword may include original data bits and additional redundancy bits introduced during a channel coding process 405 at the transmitter 402. In some examples, the codeword may be the unit of data transmission over the physical layer, which may enable robustness against channel impairments (such as noise and/or interference). Therefore, transmission of the codeword by the transmitter 402 enables the receiver 404 to detect and correct errors, improving the reliability of communication.

In some examples, the transmitter 402 may transmit one or more codewords concurrently in MIMO systems, in accordance with a rank of transmission. For instance, transmission of one codeword may be supported if the number of associated layers (e.g., spatial layers or spatial streams) is less than or equal to four. Additionally, concurrent transmission of up to two codewords may be supported if the number of associated spatial layers is greater than four. In some examples, the number of concurrent codeword transmissions via a number of MIMO spatial layers may be based on and/or in accordance with a hardware implementation at the network node 110 and/or the UE 120. In some examples, any number of the codewords may be concurrently transmitted via any number of spatial layers.

In some examples, a set of MIMO spatial layers may be respectively associated with a set of signal quality values relative to a channel noise 425. With reference to example 400 and example 455 (shown in FIG. 4B and described in more detail below), signal quality of a spatial layer may be described with reference to SNR. However, in other implementations of example 400, “signal quality” may refer to one or more other signal quality metrics, such as one or more of RSRP, RSRQ, signal-to-interference-plus-noise ratio (SINR), CQI, block error rate (BLER), bit error rate (BER), error vector magnitude (EVM), DMRS-SINR, and/or RSSI.

In some examples, the channel coding process 405 may be associated with SVD precoding. For example, SVD precoding may decompose the channel matrix into a set of components that includes a first unitary matrix representing the transmitter 402 spatial directions, a diagonal matrix that includes values associated with channel gain for each spatial layer, and a second unitary matrix associated with the receiver 404 spatial directions. The SVD decomposition may enable the transmitter 402 to precode data streams in alignment with a set of eigenmodes associated with a channel 420 (sometimes referred to herein as H) used for transmission. In some examples, aligning the precoded data streams with the set of eigenmodes may respectively increase the SNR across the set of spatial layers, which may result in a different SNR associated with each spatial layer.

In accordance with codebook-based and non-codebook-based MIMO precoding, spatial layer SNR imbalance may reduce the quality of a codeword transmission. For example, in cases where a coding rate associated with transmission is above a coding rate threshold (e.g., a relatively high coding rate), decoding at the receiver 404 may be relative to a spatial layer associated with the lowest SNR. In other words, decoding performance at the receiver 404 may be limited by the lowest SNR across a set of MIMO spatial layers, which may reduce an ability of the receiver 404 to decode the received codeword.

Accordingly, in some other examples, the channel coding process 405 may be associated with a precoding procedure that enables equalizing signal quality across a set of MIMO spatial layers. Put another way, the transmitter 402 may use a precoder 415 (sometimes referred to herein as F) associated with balancing SNR across the set of MIMO spatial layers. In some examples, the precoder 415 may be associated with GMD precoding, such as a zero-forcing GMD precoder, among other examples. In such examples, a GMD transceiver may transform the system into M independent scalar Gaussian channels with a same SINR. In such examples, the receiver 404 may be associated with a demapper 430, which may be a decision feedback equalization (DFE) demapper, a vertical Bell Laboratories spatial layered space-time (VBLAST) demapper, or a similar demapper. The demapper 430 may be associated with an optimal GMD DFE transceiver for MIMO channels that minimizes an arithmetic mean squared error (MSE), that minimizes an average BER in high SNR, or that achieves channel capacity with the same MCS on each stream in high SNR environments without a need for multiple TBs, among other examples.

In some examples, the demapper 430 may be associated with a feed forward equalizer 435 (sometimes referred to herein as G), a hard slicing component 440, and a feedback equalizer 445 (sometimes referred to herein as B), which are used, in combination, to determine a decoded wireless message 450 (e.g., sometimes referred to herein as â, which may correspond to a decoded version of the wireless message 410). More particularly, the demapper 430 may apply GMD on the channel 420 (e.g., H), which may be represented as H=QRP^{H}=QD_{R}(I+B)P^{H}, where P and Q are semi-unitary matrices, R is upper triangular matrix and may be expressed as R=D_{R}(I+B), D_{R} is diagonal matrix with Rᵢᵢ on its diagonal, I is an identity matrix, and B corresponds to the feedback equalizer 445. In such examples, P may be equal to the precoder 415 (e.g., P=F) and the feed forward equalizer 435 (e.g., G) may be expressed as

$$G = {D}_{R}^{- 1} {Q}^{H} .$$

In some examples, use of a GMD precoder in this way may result in certain SNR gains, such as a 4 dB gain over an SVD precoder in high SNR regions due to rebalancing the per-layer SNR, among other examples.

In some examples, a GMD DFE transceiver (e.g., a transceiver associated with GMD precoding and DFE equalization) may be used to equalize the SNR per scheduled layer so that a single MCS used across all layers may be able to achieve a channel capacity (whereas SVD precoding may require matching MCS per layer to achieve the channel capacity). In this regard, it may be beneficial to use a GMD DFE transceiver for improved uplink MU-MIMO communications, among other examples. For example, FIG. 4B shows an example 455 in which the demapper 430 is used at a network node 110 in connection with an uplink MU-MIMO communication associated with two UEs, shown in example 455 as a first UE 120-1 (indexed as UE0 in FIG. 4B) and a second UE 120-2 (indexed as UE1 in FIG. 4B), and the network node 110. In some other examples, an uplink MU-MIMO communication may be associated with more than two UEs 120 (e.g., an uplink MU-MIMO communication may be associated with K UEs 120) without departing from the scope of the disclosure.

In the example 455, the first UE 120-1 may use a first channel coding process 405-1 that encodes a first wireless message 410-1 using a first precoder 415-1 (sometimes referred to herein as F₀), and which is transmitted through a first channel 420-1 (sometimes referred to herein as H₀, and which may be associated with first channel noise 425-1) to the demapper 430 as a first layer of the uplink MU-MIMO communication. Similarly, the second UE 120-2 may use a second channel coding process 405-2 that encodes a second wireless message 410-2 using a second precoder 415-2 (sometimes referred to herein as F₁), and which is transmitted through a second channel 420-2 (sometimes referred to herein as H₁, and which may be associated with second channel noise 425-2) to the demapper 430 as a second layer of the uplink MU-MIMO communication.

The demapper 430 may decode the uplink MU-MIMO communication in a similar manner as described above in connection with FIG. 4A. However, in some examples of uplink MU-MIMO, the cross-layers interference among the UEs 120 (e.g., the first UE 120-1 and the second UE 120-2 in example 455) may cause communication errors. Accordingly, in some examples, the demapper 430 may perform a joint modulation for all layers across SDMed UEs 120 in order to enable successive cancellation of interference from the different UEs 120 and layers, thus improving communication performance. For example, for a zero-forcing VBLAST or DFE demapper, matrix Q and matrix R (QR) decomposition may applied on channels

$$[ \begin{matrix}{H}_{0} \\ {H}_{1}\end{matrix} ] = QR = {QD}_{R} ( I + B )$$

to obtain the feed forward equalizer

$$G = {D}_{R}^{- 1} {Q}^{H}$$

and feedback equalizer D, where D_{R} is a diagonal matrix including diagonal elements of R matrix and B is a strictly upper triangular matrix (such as the upper triangular matrix shown in connection with the feedback equalizer 445 in FIG. 4B). In such examples, the per-layer SNR for the i^{th} layer is SNRᵢ=|rᵢᵢ|² for zero-forcing VBLAST (ZF-VBLAST) and SNRᵢ=|rᵢᵢ|²−1 for minimum-mean-square-error VBLAST (MMSE-VBLAST), assuming noise variance

$${σ}_{n}^{2} = 1.$$

However, it may not be possible to utilize GMD precoding in each UE 120 of an uplink MU-MIMO communication in order to achieve equal SNR across layers while enabling the network node 110 to perform joint VBLAST or DFE demapping to cancel inter-UE and inter-layer interference, because per-UE GMD, in which

$${H}_{i} = {Q}_{i} {R}_{i} {P}_{i}^{H} ,$$

may only be able to achieve per-UE decoding and thus does not guarantee inter-UE interference cancellation without joint demodulation.

Accordingly, in some examples, it may be beneficial to employ certain decomposition schemes that enable equalization of SNR across spatial layers in addition to cancellation of inter-UE and inter-layer interference, such as BD-GMD (sometimes referred to herein more broadly as block diagonal generalized triangular decomposition (BD-GTD)). For example, in BD-GMD an equivalent uplink channel from two UEs (e.g., H, which may be represented as H=[H₀ H₁]) may be decomposed as

$$[ \begin{matrix}{H}_{0} & {H}_{1}\end{matrix} ] = [ \begin{matrix}{Q}_{0} & {Q}_{1}\end{matrix} ] [ \begin{matrix}{R}_{0} & A \\ 0 & {R}_{1}\end{matrix} ] [ \begin{matrix}{P}_{0}^{H} & 0 \\ 0 & {P}_{1}^{H}\end{matrix} ] ,$$

where Hᵢ∈C^{J×n}^{ᵢ}, Qᵢ∈C^{J×n}^{ᵢ} is a unitary matrix; Rᵢ∈Cⁿ^{ᵢ}^{×n}^{ᵢ} is an upper triangular matrix with equal diagonal elements; Pᵢ∈Cⁿ^{ᵢ}^{×n}^{ᵢ} is a unitary matrix; P₀, R₀, and Q₀ may be obtained by performing GMD on

$${H}_{0} ( e . g . , {H}_{0} = {Q}_{0} {R}_{0} {P}_{0}^{H} ) ; {P}_{1} , {R}_{1} ,$$

and Q₁ may be obtained by performing GMD on

$${\tilde{H}}_{1} = ( I - {Q}_{0} {Q}_{0}^{H} ) {H}_{1} ( e . g . , {\tilde{H}}_{1} = {Q}_{1} {R}_{1} {P}_{1}^{H} ) ; and A = {Q}_{0} \text{?} {P}_{1}^{H} .$$

Moreover, BD-GMD may be generalized for K UEs 120 by iteratively applying BD-GMD on H₁ above, assuming H₁=[H₁ H₂ . . . . H_{K-1}]. In such examples,

$$[ \begin{matrix}{H}_{0} & … & {H}_{K - 1}\end{matrix} ] = [ \begin{matrix}{Q}_{0} & … & {Q}_{K - 1}\end{matrix} ] [ \begin{matrix}{R}_{0} & \times & \times \\ 0 & ⋱ & \times \\ 0 & 0 & {R}_{K - 1}\end{matrix} ] [ \begin{matrix}{P}_{0}^{H} & 0 & 0 \\ 0 & ⋱ & 0 \\ 0 & 0 & {P}_{K - 1}^{H}\end{matrix} ] = {QRP}^{H} = {QD}_{R} ( I + B ) {P}^{H} .$$

In such cases, a demapper 430 may apply GMD on

$${\tilde{H}}_{i} = {\prod }_{j = i - 1}^{0} ( I - {Q}_{j} {Q}_{j}^{H} ) {H}_{i} to get ( {P}_{i} , {R}_{i} , {Q}_{i} ) ( e . g . , {\tilde{H}}_{i} = {\prod }_{j = i - 1}^{0} ( I - {Q}_{j} {Q}_{j}^{H} ) {H}_{i} = {Q}_{i} {R}_{i} {P}_{i}^{H} ) ,$$

with the diagonal elements of Rᵢ (rᵢ) being constant and the geometric mean of singular values of \tilde{H}ᵢ. That is,

$${r}_{i} = {( \frac{det ( {\text{?}}^{H} \text{?}}{det ( {\text{?}}^{H} \text{?}} )}^{\frac{1}{2 {n}_{i}}} , where \text{?} = [ \begin{matrix}{H}_{0} & {H}_{1} & … & {H}_{i}\end{matrix} ] .$$

Although, it may be beneficial to employ BD-GMD for uplink MU-MIMO communications enable equalization of SNR across spatial layers in addition to cancellation of inter-UE and inter-layer interference, current wireless communication systems may not support BD-GMD-based uplink MU-MIMO communications. This is because a UE 120 associated with an uplink MU-MIMO communication may not be aware of channels of the other UEs 120 associated with the uplink MU-MIMO communication. More particularly, returning to the example 455 shown in FIG. 4B, the first UE 120-1 (e.g., UE0) may not be aware of the second UE 120-2's channel, and, similarly, the second UE 120-2 may not be aware of the first UE 120-1's channel. Accordingly, the UEs 120 may be unable to determine a respective precoder (e.g., Fᵢ) for the uplink MU-MIMO communication. As a result, wireless communication systems may forgo uplink MU-MIMO communications altogether (e.g., to avoid communication errors caused by cross-layer interference among the UE 120), resulting in inefficient usage of network resources and thus high latency and low throughput. On the other hand, for wireless communication systems employing uplink MU-MIMO communications, the uplink MU-MIMO communications may result in a high incidence of cross-layer interference, leading to communication errors and thus high computing, power, and network resource consumption for correcting communication errors.

Some aspects and techniques described herein enable uplink MU-MIMO communications by signaling of uplink precoders associated with uplink MU-MIMO communications. In some aspects, a network node may transmit, and a UE may receive, an indication of an uplink precoder for an uplink MU-MIMO communication that is associated with the UE and one or more other UEs. Additionally, or alternatively, the UE may transmit, and the network node may receive, an uplink transmission associated with the uplink MU-MIMO communication based at least in part on using the uplink precoder. As a result, the MU-MIMO communication may enable multiple UEs to communicate in the uplink using overlapping communications in the time or frequency domain, thereby reducing latency, increasing throughput, and otherwise resulting in more efficient usage of network resources. Moreover, by the network node signaling the uplink precoders associated with the MU-MIMO communication to various UEs, the network node may equalize or balance SNRs across the spatial layers of the uplink MU-MIMO communication while minimizing inter-UE or inter-layer interference (e.g., by employing BD-GMD), which may increase the data rate of an equivalent uplink channel relative to the Shannon capacity (e.g., the theoretical maximum data rate that the channel may achieve), thus resulting in more efficient usage of network resources or reduced communication errors and thus conservation of computing, power, network, and/or communication resources that may have otherwise been consumed to detect and/or correct communication errors.

As indicated above, FIGS. 4A-4B are provided as examples. Other examples may differ from what is described with regard to FIGS. 4A-4B.

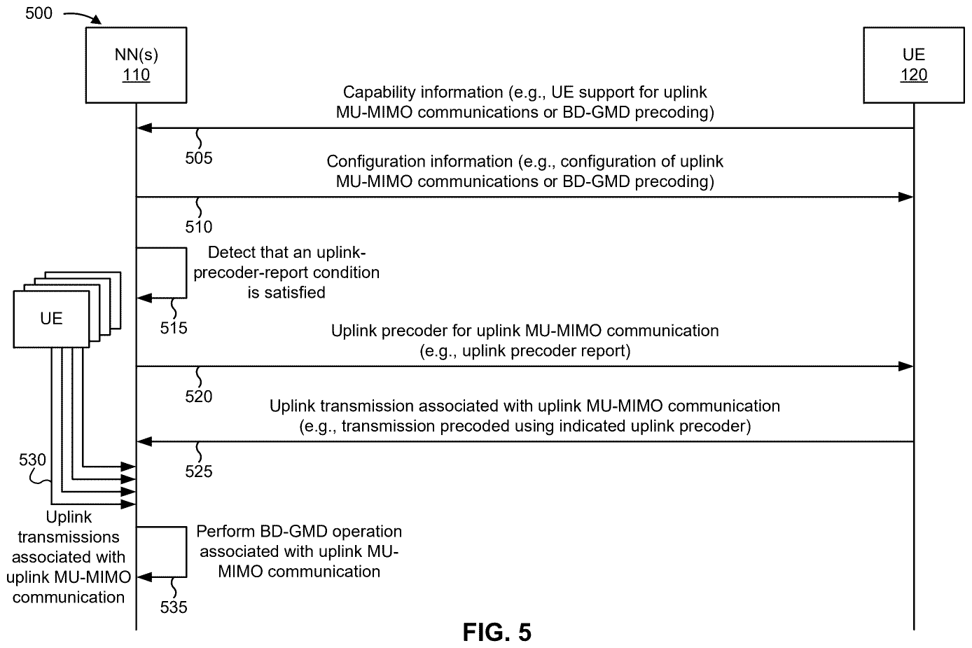

FIG. 5 is a diagram of an example 500 associated with precoding uplink MU-MIMO communications. As shown in FIG. 5, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 5. In some aspects, the UE 120 and the network node 110 may be capable of performing an uplink MU-MIMO communication, such as by the UE 120 transmitting, and the network node 110 receiving, an uplink transmission as one layer of the uplink MU-MIMO communication. In such aspects, additional UEs 120 may be part of the wireless network or the network node 110 may have established a wireless connection with multiple other UEs 120 (e.g., the multiple other UEs 120 described below in connection with reference number 530) prior to the operations shown in FIG. 5.

In some aspects, as shown by reference number 505, the UE 120 may transmit capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for performing uplink MU-MIMO communications. As another example, the capability information may indicate a capability or parameter for performing GMD precoding (e.g., BD-GMD precoding), such as precoding associated with a BD-GMD operation performed at the network node 110. One or more operations described herein may be based on capability information. For example, the UE 120 may perform a communication in accordance with the capability information, or may receive configuration information that is in accordance with the capability information. In some aspects, the capability information may indicate UE support for receiving an indication of an uplink precoder for an uplink MU-MIMO communication associated with the UE 120 and one or more other UEs (e.g., the UEs described below in connection with reference number 530), and transmitting an uplink transmission associated with the uplink MU-MIMO communication that is based at least in part on using the uplink precoder.

As shown by reference number 510, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node 110 or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to communicate with the network node 110 using an uplink MU-MIMO communication (e.g., that the UE 120 is to transmit an uplink communication as one layer of an uplink MU-MIMO communication). Additionally, or alternatively, the configuration information may indicate one or more parameters associated with the uplink MU-MIMO communication. For example, the configuration information may indicate that the uplink MU-MIMO communication is associated with a BD-GMD operation or similar GMD operation, or that the UE 120 is to use an uplink precoder associated with a BD-GMD operation or a similar GMD operation, among other examples.

In some aspects, the configuration information may indicate resources associated with the UE 120 receiving an indication of an uplink precoder to be used for an uplink MU-MIMO communication. For example, as described in more detail below in connection with reference number 520, in some aspects, the network node 110 may indicate the uplink precoder using an uplink precoder report. In such aspects, the uplink precoder report may be periodic uplink precoder report associated with a periodicity. Accordingly, the configuration information may indicate the periodicity or periodic resources for receiving the uplink precoder report. In some other aspects, the uplink precoder report may be a semi-periodic report associated with a minimum periodicity (sometimes referred to herein as Tₘᵢₙ) and a maximum periodicity (sometimes referred to herein as Tₘₐₓ). In such aspects, the configuration information may indicate the minimum periodicity (e.g., Tₘᵢₙ) or the maximum periodicity (e.g., Tₘₐₓ), among other examples.

Additionally, or alternatively, in some aspects the uplink precoder may be a codebook-based precoder. “Codebook” refers to a set of candidate codewords (sometimes referred to herein as beamforming matrices, precoding matrices, or precoders) to be used by a wireless communication device in MIMO communications (e.g., uplink MU-MIMO communications). In codebook-based uplink MU-MIMO communications, a UE may use a codeword (e.g., a precoder) that is selected from a standardized uplink codebook (e.g., a codebook defined by a wireless communication standard, such as a standard promulgated by the 3GPP). In such aspects, the configuration information may indicate that the UE 120 is to use a codebook-based uplink precoder or may indicate a certain codebook associated with the codebook-based uplink precoder, among other parameters associated with the codebook-based uplink precoder.

The UE 120 may configure itself based at least in part on the configuration information. In some aspects, the UE 120 may be configured to perform one or more operations described herein based at least in part on the configuration information.

As indicated by reference number 515, the network node 110 may detect that an uplink-precoder-report condition is satisfied. In some aspects, the precoder-report condition may be a condition indicative that a previously transmitted uplink precoder report (and thus an uplink precoder indicated by the previously transmitted uplink precoder report) is outdated or obsolete, such as the network node 110 switching a reception beam, the network node 110 detecting a sudden change in an uplink channel, or a similar condition.

As indicated by reference number 520, the network node 110 may transmit, and the UE 120 may receive, an indication of an uplink precoder for an uplink MU-MIMO communication that is associated with the UE 120 and one or more other UEs (e.g., the one or more other UEs described below in connection with reference number 530). In some aspects, such as aspects in which the network node 110 is associated with a GMD operation (e.g., a BD-GMD operation, among other examples), the uplink precoder may be associated with a unitary matrix (e.g., a square matrix, represented by U, in that satisfies the condition U^{T}U=UU^{T}=I, where U^{T} is the transpose of U and I is the identity matrix), in a similar manner as described above in connection with FIGS. 4A-4B. Put another way, the network node 110 may determine a corresponding unitary matrix precoder (e.g., Pᵢ) for each UE (e.g., UEᵢ) associated with an uplink MU-MIMO communication, and thus the network node 110 may signal the corresponding unitary precoder to each UE.

In some aspects, the indication of the uplink precoder may be a quantized indication of the uplink precoder received by the UE 120 via at least one of a DCI communication or a MAC-CE. For example, returning to the aspects described above in which the network node signals a unitary matrix precoder (e.g., Pᵢ) to each UE (e.g., UEᵢ) associated with the uplink MU-MIMO communication, each unitary matrix precoder may be quantized and indicated to the respective UE via a respective DCI communication. Additionally, or alternatively, a unitary matrix precoder (e.g., Pᵢ) may be quantized in raw bits and transmitted in first stage DCI, second stage DCI, or a MAC-CE, among other examples.

In some aspects, the uplink precoder may be associated with a sub-band used to transmit the uplink transmission associated with the uplink MU-MIMO communication. For example, based at least in part on a precoding granularity, among other examples, the network node 110 may select or signal one uplink precoder (sometimes referred to herein as Pᵢ(k)) per sub-band (e.g., the network node 110 may signal Pᵢ(k) for sub-band k). In some aspects, a size of sub-band k (which, as described above, may be equal to a precoding granularity associated with the network node 110) may be equal to a precoding resource group (PRG) size associated with the uplink MU-MIMO communication (e.g., a quantity of contiguous physical resource blocks (PRBs) over which the same precoding is applied for a given transmission associated with the uplink MU-MIMO communication). Additionally, or alternatively, in some aspects, the elements of the uplink precoder (e.g., Pᵢ(k)) in sub-band k may be quantized as (wideband amplitude, wideband phase) x (sub-band k amplitude, sub-band k phase), which is sometimes referred to herein as

$${α}_{WB} {e}^{j {ϕ}_{WB}} \cdot {α}_{SB} ( k ) {e}^{j {ϕ}_{SB} ( k )} .$$

In some aspects, the indication of the uplink precoder may be based at least in part on a preferred precoder indicated by the UE 120. For example, in aspects involving frequency division duplex (FDD) systems, among other examples, the UE 120 may report a preferred precoder, such as via a type-1 or (e)type-2 codebook in a CSI report, which may assist the network node 110 is choosing a best downlink precoder for network node 110 transmissions, among other examples. Additionally, or alternatively, the network node 110 may indicate the uplink precoder for a given transmission (e.g., an uplink transmission associated with the uplink MU-MIMO communication), such as via a scheduling grant (e.g., an uplink scheduling DCI) for that transmission, among other examples.

In some other aspects, to save overhead associated with indicating a corresponding uplink precoder in each scheduling grant, among other examples, the network node 110 may indicate the uplink precoder via an uplink precoder report. Put another way, the indication of the uplink precoder (e.g., Pᵢ) shown in connection with reference number 520 may be indicated via an uplink precoder report. In such aspects, the uplink precoder report may indicate that the UE 120 is to apply the indicated uplink precoder after receiving the report. In some aspects, the precoder report may be associated with a precoder application time offset, which may be indicated by the configuration information described above in connection with reference number 510, or which may be predefined via a relevant wireless communication standard (e.g., a wireless communication standard promulgated by the 3GPP) and that is hard-coded at the UE 120, that is pre-configured at the UE 120, or that is otherwise indicated to the UE 120 (e.g., via an OEM configuration, among other examples). In such aspects, the uplink precoder report may indicate that the UE 120 is to apply the indicated uplink precoder for any uplink transmissions that occur a time period after receiving the report that is greater than or equal to the precoder application time offset.

In aspects involving the uplink precoder report (e.g., in aspects in which the indication of the uplink precoder shown in connection with reference number 520 is transmitted by the network node 110 and received by the UE 120 via an uplink precoder report), the uplink precoder report may be periodic, semi-periodic, or event-driven, among other examples. More particularly, in some aspects, the uplink precoder report may be a periodic uplink precoder report associated with a periodicity (e.g., a periodicity indicated by the configuration information described above in connection with reference number 510, among other examples). For example, the network node 110 may transmit, and the UE 120 may receive, an indication of the uplink precoder (e.g., Pᵢ) in a first stage DCI, a second stage DCI, or a MAC-CE with a preconfigured periodicity.

In some other aspects, the uplink precoder report may be a semi-periodic report associated with at least one of a minimum periodicity (e.g., Tₘᵢₙ) or a maximum periodicity (e.g., Tₘₐₓ) (with the values of the minimum periodicity or the maximum periodicity indicated to the UE 120 via the configuration information described above in connection with reference number 510, among other examples). In such aspects, the network node 110 may transmit, and the UE 120 may receive, an indication of the uplink precoder (e.g., Pᵢ) in a first stage DCI, a second stage DCI, or a MAC-CE that is transmitted based at least in part on the minimum periodicity (e.g., Tₘᵢₙ) and the maximum periodicity (e.g., Tₘₐₓ). More particularly, each instance of the uplink precoder report may be transmitted by the network node 110 a time period after a previously transmitted uplink precoder report that is greater than or equal to the minimum periodicity (e.g., Tₘᵢₙ) and less than or equal to the maximum periodicity (e.g., Tₘₐₓ).

Additionally, or alternatively, the network node 110 may transmit the semi-periodic uplink precoder report via a message in which the uplink precoder report is transmitted in combination with one of a PDCCH communication or a PDSCH communication (e.g., the uplink precoder report may piggyback on a scheduled PDCCH/PDSCH), or else a standalone uplink precoder report message (e.g., a DCI, MAC-CE, or similar message). For example, the network node 110 may opportunistically transmit the uplink precoder report by piggybacking the uplink precoder report on a scheduled PDCCH/PDSCH when a last transmitted uplink precoder report was transmitted at least Tₘᵢₙ before the scheduled PDCCH/PDSCH. However, if there is no PDCCH/PDSCH for traffic to piggyback with and the last transmitted report occurred Tₘₐₓ less some predefined delta (sometimes referred to herein as δ), the network node 110 may schedule the semi-periodic uplink precoder report and thus transmit the semi-periodic uplink precoder report using a standalone uplink precoder report message (e.g., a message that does not piggyback on a scheduled PDCCH/PDSCH), among other examples.

In some other aspects, the uplink precoder report may be an event-driven uplink precoder report. In such aspects, the network node 110 may transmit, and the UE 120 may receive, the uplink precoder report based at least in part on a condition being satisfied (e.g., one of the conditions described above in connection with reference number 515, among other examples). For example, and in a similar manner as described above in connection with reference number 515, if the network node 110 detects a periodic uplink precoder report is outdated (such as because the network node 110 switched a reception beam or detected a sudden change in an uplink channel, among other examples), the network node 110 may schedule an uplink precoder report before an uplink transmission (e.g., the uplink transmission described below in connection with reference number 525) via a first-stage DCI, a second-stage DCI, or a MAC-CE, among other examples.

In some aspects, the uplink precoder (e.g., Pᵢ) may be a codebook-based uplink precoder (e.g., a precoder that is selected from a codebook of candidate precoders, with the codebook being defined by a relevant wireless communication standard, such as a standard promulgated by the 3GPP, among other examples). For example, in aspects in which a layer imbalance is relatively small among the various UEs, the Pᵢ may be a codebook-based uplink precoder, among other examples. More particularly, in examples in which Pᵢ is not an SVD right vector of

$${\tilde{H}}_{i} ( where {\tilde{H}}_{i} = {\prod }_{j = i - 1}^{0} ( I - {Q}_{j} {Q}_{j}^{H} ) {H}_{i} = {Q}_{i} {R}_{i} {P}_{i}^{H} ) ,$$

the diagonal value of Rᵢ, or an equivalent vector, the per-layer SNR for UEᵢ may be relatively equal (e.g., the per-layer SNR for UEᵢ may be may be more equal than a case in which an SVD precoder is used). In such aspects, for a given Pᵢ, the network node 110 may be able to perform QR decomposition on \tilde{H}ᵢPᵢ to obtain Qᵢ and Rᵢ. Moreover, in such examples and according to a GTD theorem, any Pᵢ will give more equal diagonal values on Rᵢ than singular vector of \tilde{H}ᵢ.

In that regard, in some aspects (e.g., aspects involving relatively small layer imbalance associated with the uplink MU-MIMO communication), the network node 110 may simply indicate a codebook-based uplink precoder, such as by indicating an index (e.g., PMI) that corresponds to the uplink precoder in an uplink precoder codebook. Put another way, the network node 110 may indicate the codebook-based uplink precoder via a PMI included in DCI, a MAC-CE, an uplink precoder report, or a similar message. Additionally, or alternatively, in aspects involving a codebook-based uplink precoder, the network node 110 may select a codebook-based uplink precoder in order to achieve a lowest possible layer imbalance associated with an uplink MU-MIMO communication. For example, the network node 110 may evaluate each uplink precoder in an uplink precoder codebook to determine which uplink precoder results in the most equal diagonal elements of Rᵢ, and signal the uplink precoder that results in the most equal diagonal elements of Rᵢ to the UE 120, among other examples.

As indicated by reference number 525, the UE 120 may transmit, and the network node 110 may receive, an uplink transmission associated with the uplink MU-MIMO communication based at least in part on using the uplink precoder. Put another, way, the UE 120 may transmit, as one layer of an uplink MU-MIMO communication, an uplink transmission that is precoded using the uplink precoder indicated to the UE 120 by the network node 110 (e.g., via the operations described above in connection with reference number 520). Moreover, as indicated by reference number 530, other UEs associated with the uplink MU-MIMO communication may transmit respective uplink transmissions associated with the uplink MU-MIMO communication based at least in part on using respective uplink precoders (e.g., precoders signaled to the other UEs in a similar manner as described above in connection with reference number 525).

As indicated by reference number 535, the network node 110 may perform a decomposition operation associated with the uplink MU-MIMO communication, such as a decomposition operation that is associated with a BD-GMD operation, among other examples. Put another way, in some aspects, the network node 110 may apply BD-GMD for the uplink channel to come up with a per-UE precoder (which may be signaled to each of the UEs as described above in connection with reference number 520) or the network node 110's feedforward matrix (e.g., feed forward equalizer) and feedback matrix (e.g., the feedback equalizer 445). The network node 110 may thus use a demapper (e.g., demapper 430) associated with the determined feedforward matrix or feedback matrix to decode uplink transmissions from the multiple UEs associated with the uplink MU-MIMO communication.

In some aspects, and in a similar manner as described above in connection with FIG. 4B, the network node 110 may estimate the equivalent uplink channel

$$( e . g . , [ \begin{matrix}{H}_{0} \\ {H}_{1}\end{matrix} ]$$

for examples involving two UEs, but which more generally may include H₀ through H_{K} values in aspects involving K UEs) from SRS sounding at the network node 110. Moreover, for aspects associated with a zero-forcing demapper, the network node 110 may apply BD-GMD on

$$[ \begin{matrix}{H}_{0} & … & {H}_{K - 1}\end{matrix} ] = Q [ \begin{matrix}{R}_{0} & \times & \times \\ 0 & ⋱ & \times \\ 0 & 0 & {R}_{K - 1}\end{matrix} ] [ \begin{matrix}{P}_{0}^{H} & 0 & 0 \\ 0 & ⋱ & 0 \\ 0 & 0 & {P}_{K - 1}^{H}\end{matrix} ] = {QRP}^{H} = {QD}_{R} ( I + B ) {P}^{H} ,$$

in order to determine the feed forward matrix

$$G ( e . g . , G = {D}_{R}^{- 1} {Q}^{H} )$$

and the feedback matrix B (e.g., R=D_{R}(I+B)) for the joint DFE demapper (e.g., a zero-forcing VBLAST demapper, among other examples), with the precoder for UEᵢ (e.g., Fᵢ) being equal to Pᵢ.

Based at least in part on the UE 120 and the network node 110 communicating using an uplink precoder that is associated with an uplink MU-MIMO communication, the UE 120 and/or the network node 110 may conserve computing, power, network, and/or communication resources that may have otherwise been consumed traditional uplink communications. For example, based at least in part on the UE 120 and the network node 110 communicating using an uplink precoder that is associated with an uplink MU-MIMO communication, the SNRs across the spatial layers of the uplink MU-MIMO communication may be equalized or balanced or inter-UE or inter-layer interference may be accounted for at the network node 110 (e.g., in aspects involving a BD-GMD operation, among other examples), which may increase the data rate of an equivalent uplink channel relative to the Shannon capacity (e.g., the theoretical maximum data rate that the channel may achieve), thus resulting in more efficient usage of network resources or reduced communication errors and thus conservation of computing, power, network, and/or communication resources that may have otherwise been consumed to detect and/or correct communication errors.

As indicated above, FIG. 5 is provided as an example. Other examples may differ from what is described with respect to FIG. 5.

FIG. 6 is a diagram illustrating an example process 600 performed, for example, at a UE or an apparatus of a UE. Example process 600 is an example where the apparatus or the UE (e.g., UE 120) performs operations associated with precoding uplink MU-MIMO communications.

As shown in FIG. 6, in some aspects, process 600 may include receiving an indication of an uplink precoder for an uplink MU-MIMO communication that is associated with the UE and one or more other UEs (block 610). For example, the UE (e.g., using reception component 802 or communication manager 806, depicted in FIG. 8) may receive an indication of an uplink precoder for an uplink MU-MIMO communication that is associated with the UE and one or more other UEs, as described above.

As further shown in FIG. 6, in some aspects, process 600 may include transmitting an uplink transmission associated with the uplink MU-MIMO communication based at least in part on using the uplink precoder (block 620). For example, the UE (e.g., using transmission component 804 or communication manager 806, depicted in FIG. 8) may transmit an uplink transmission associated with the uplink MU-MIMO communication based at least in part on using the uplink precoder, as described above.

Process 600 may include additional aspects, such as any single aspect or any combination of aspects described below or in connection with one or more other processes described elsewhere herein.

In a first aspect, the uplink precoder is associated with a unitary matrix.

In a second aspect, alone or in combination with the first aspect, receiving the indication of the uplink precoder includes receiving a quantized indication of the precoder via at least one of a DCI communication or a MAC-CE.

In a third aspect, alone or in combination with one or more of the first and second aspects, the uplink precoder is associated with a sub-band used to transmit the uplink transmission associated with the uplink MU-MIMO communication.

In a fourth aspect, alone or in combination with one or more of the first through third aspects, receiving the indication of the uplink precoder includes receiving the indication of the uplink precoder via an uplink precoder report.

In a fifth aspect, alone or in combination with one or more of the first through fourth aspects, the uplink precoder report is a periodic uplink precoder report associated with a periodicity.

In a sixth aspect, alone or in combination with one or more of the first through fifth aspects, the uplink precoder report is a semi-periodic report associated with at least one of a minimum periodicity or a maximum periodicity, and receiving the indication of the uplink precoder via the uplink precoder report includes receiving the uplink precoder report a time period after a previously transmitted uplink precoder report that is greater than or equal to the minimum periodicity and less than or equal to the maximum periodicity.

In a seventh aspect, alone or in combination with one or more of the first through sixth aspects, receiving the indication of the uplink precoder via the uplink precoder report includes receiving the uplink precoder report via at least one of a message in which the uplink precoder report is transmitted in combination with one of a physical downlink control channel communication or a physical downlink shared channel communication, or a standalone uplink precoder report message.

In an eighth aspect, alone or in combination with one or more of the first through seventh aspects, receiving the indication of the uplink precoder via the uplink precoder report includes receiving the uplink precoder report based at least in part on at least one of a switch of a reception beam associated with a network node, or a change in an uplink channel associated with the network node.

In a ninth aspect, alone or in combination with one or more of the first through eighth aspects, the uplink precoder is a codebook-based uplink precoder, and receiving the indication of the uplink precoder includes receiving an indication of an index that corresponds to the uplink precoder in an uplink precoder codebook.

In a tenth aspect, alone or in combination with one or more of the first through ninth aspects, the uplink MU-MIMO communication is associated with a block diagonal geometric mean decomposition operation associated with a network node.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with precoding uplink MU-MIMO communications.

As shown in FIG. 7, in some aspects, process 700 may include transmitting, to a UE, an indication of an uplink precoder for an uplink MU-MIMO communication that is associated with the UE and one or more other UEs (block 710). For example, the network node (e.g., using transmission component 904 or communication manager 906, depicted in FIG. 9) may transmit, to a UE, an indication of an uplink precoder for an uplink MU-MIMO communication that is associated with the UE and one or more other UEs, as described above.

As further shown in FIG. 7, in some aspects, process 700 may include receiving, from the UE, an uplink transmission associated with the uplink MU-MIMO communication that is based at least in part on the uplink precoder (block 720). For example, the network node (e.g., using reception component 902 or communication manager 906, depicted in FIG. 9) may receive, from the UE, an uplink transmission associated with the uplink MU-MIMO communication that is based at least in part on the uplink precoder, as described above.

Process 700 may include additional aspects, such as any single aspect or any combination of aspects described below or in connection with one or more other processes described elsewhere herein.

In a first aspect, the uplink precoder is associated with a unitary matrix.

In a second aspect, alone or in combination with the first aspect, transmitting the indication of the uplink precoder includes transmitting a quantized indication of the precoder via at least one of a DCI communication or a MAC-CE.

In a third aspect, alone or in combination with one or more of the first and second aspects, the uplink precoder is associated with a sub-band used to receive the uplink transmission associated with the uplink MU-MIMO communication.

In a fourth aspect, alone or in combination with one or more of the first through third aspects, transmitting the indication of the uplink precoder includes transmitting the indication of the uplink precoder via an uplink precoder report.

In a fifth aspect, alone or in combination with one or more of the first through fourth aspects, the uplink precoder report is a periodic uplink precoder report associated with a periodicity.

In a sixth aspect, alone or in combination with one or more of the first through fifth aspects, the uplink precoder report is a semi-periodic report associated with at least one of a minimum periodicity or a maximum periodicity, and transmitting the indication of the uplink precoder via the uplink precoder report includes transmitting the uplink precoder report a time period after a previously transmitted uplink precoder report that is greater than or equal to the minimum periodicity and less than or equal to the maximum periodicity.

In a seventh aspect, alone or in combination with one or more of the first through sixth aspects, transmitting the indication of the uplink precoder via the uplink precoder report includes transmitting the uplink precoder report via at least one of a message in which the uplink precoder report is transmitted in combination with one of a physical downlink control channel communication or a physical downlink shared channel communication, or a standalone uplink precoder report message.

In an eighth aspect, alone or in combination with one or more of the first through seventh aspects, transmitting the indication of the uplink precoder via the uplink precoder report includes transmitting the uplink precoder report based at least in part on at least one of a switch of a reception beam associated with the network node, or a change in an uplink channel associated with the network node.

In a ninth aspect, alone or in combination with one or more of the first through eighth aspects, the uplink precoder is a codebook-based uplink precoder, and transmitting the indication of the uplink precoder includes transmitting an indication of an index that corresponds to the uplink precoder in an uplink precoder codebook.

In a tenth aspect, alone or in combination with one or more of the first through ninth aspects, the uplink MU-MIMO communication is associated with a block diagonal geometric mean decomposition operation associated with the network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive an indication of an uplink precoder for an uplink MU-MIMO communication that is associated with the UE and one or more other UEs. The transmission component 804 may transmit an uplink transmission associated with the uplink MU-MIMO communication based at least in part on using the uplink precoder.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, an indication of an uplink precoder for an uplink MU-MIMO communication that is associated with the UE and one or more other UEs. The reception component 902 may receive, from the UE, an uplink transmission associated with the uplink MU-MIMO communication that is based at least in part on the uplink precoder.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving an indication of an uplink precoder for an uplink multi-user multiple input multiple output (MU-MIMO) communication that is associated with the UE and one or more other UEs; and transmitting an uplink transmission associated with the uplink MU-MIMO communication based at least in part on using the uplink precoder.

Aspect 2: The method of Aspect 1, wherein the uplink precoder is associated with a unitary matrix.

Aspect 3: The method of any of Aspects 1-2, wherein receiving the indication of the uplink precoder includes receiving a quantized indication of the precoder via at least one of a downlink control information (DCI) communication or a medium access control (MAC) control element (MAC-CE).

Aspect 4: The method of any of Aspects 1-3, wherein the uplink precoder is associated with a sub-band used to transmit the uplink transmission associated with the uplink MU-MIMO communication.

Aspect 5: The method of any of Aspects 1-4, wherein receiving the indication of the uplink precoder includes receiving the indication of the uplink precoder via an uplink precoder report.

Aspect 6: The method of Aspect 5, wherein the uplink precoder report is a periodic uplink precoder report associated with a periodicity.

Aspect 7: The method of Aspect 5, wherein the uplink precoder report is a semi-periodic report associated with at least one of a minimum periodicity or a maximum periodicity, and wherein receiving the indication of the uplink precoder via the uplink precoder report includes receiving the uplink precoder report a time period after a previously transmitted uplink precoder report that is greater than or equal to the minimum periodicity and less than or equal to the maximum periodicity.

Aspect 8: The method of Aspect 7, wherein receiving the indication of the uplink precoder via the uplink precoder report includes receiving the uplink precoder report via at least one of: a message in which the uplink precoder report is transmitted in combination with one of a physical downlink control channel communication or a physical downlink shared channel communication, or a standalone uplink precoder report message.

Aspect 9: The method of Aspect 5, wherein receiving the indication of the uplink precoder via the uplink precoder report includes receiving the uplink precoder report based at least in part on at least one of a switch of a reception beam associated with a network node, or a change in an uplink channel associated with the network node.

Aspect 10: The method of any of Aspects 1-9, wherein the uplink precoder is a codebook-based uplink precoder, and wherein receiving the indication of the uplink precoder includes receiving an indication of an index that corresponds to the uplink precoder in an uplink precoder codebook.

Aspect 11: The method of any of Aspects 1-10, wherein the uplink MU-MIMO communication is associated with a block diagonal geometric mean decomposition operation associated with a network node.

Aspect 12: A method of wireless communication performed by a network node, comprising: transmitting, to a user equipment (UE), an indication of an uplink precoder for an uplink multi-user multiple input multiple output (MU-MIMO) communication that is associated with the UE and one or more other UEs; and receiving, from the UE, an uplink transmission associated with the uplink MU-MIMO communication that is based at least in part on the uplink precoder.

Aspect 13: The method of Aspect 12, wherein the uplink precoder is associated with a unitary matrix.

Aspect 14: The method of any of Aspects 12-13, wherein transmitting the indication of the uplink precoder includes transmitting a quantized indication of the precoder via at least one of a downlink control information (DCI) communication or a medium access control (MAC) control element (MAC-CE).

Aspect 15: The method of any of Aspects 12-14, wherein the uplink precoder is associated with a sub-band used to receive the uplink transmission associated with the uplink MU-MIMO communication.

Aspect 16: The method of any of Aspects 12-15, wherein transmitting the indication of the uplink precoder includes transmitting the indication of the uplink precoder via an uplink precoder report.

Aspect 17: The method of Aspect 16, wherein the uplink precoder report is a periodic uplink precoder report associated with a periodicity.

Aspect 18: The method of Aspect 16, wherein the uplink precoder report is a semi-periodic report associated with at least one of a minimum periodicity or a maximum periodicity, and wherein transmitting the indication of the uplink precoder via the uplink precoder report includes transmitting the uplink precoder report a time period after a previously transmitted uplink precoder report that is greater than or equal to the minimum periodicity and less than or equal to the maximum periodicity.

Aspect 19: The method of Aspect 18, wherein transmitting the indication of the uplink precoder via the uplink precoder report includes transmitting the uplink precoder report via at least one of: a message in which the uplink precoder report is transmitted in combination with one of a physical downlink control channel communication or a physical downlink shared channel communication, or a standalone uplink precoder report message.

Aspect 20: The method of Aspect 16, wherein transmitting the indication of the uplink precoder via the uplink precoder report includes transmitting the uplink precoder report based at least in part on at least one of a switch of a reception beam associated with the network node, or a change in an uplink channel associated with the network node.

Aspect 21: The method of any of Aspects 12-20, wherein the uplink precoder is a codebook-based uplink precoder, and wherein transmitting the indication of the uplink precoder includes transmitting an indication of an index that corresponds to the uplink precoder in an uplink precoder codebook.

Aspect 22: The method of any of Aspects 12-21, wherein the uplink MU-MIMO communication is associated with a block diagonal geometric mean decomposition operation associated with the network node.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,”’ or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more memories; and
one or more processors coupled to the one or more memories, the one or more processors individually or collectively configured to:
receive an indication of an uplink precoder for an uplink multi-user multiple input multiple output (MU-MIMO) communication that is associated with the UE and one or more other UEs; and
transmit an uplink transmission associated with the uplink MU-MIMO communication based at least in part on using the uplink precoder.

2. The UE of claim 1, wherein the uplink precoder is associated with a unitary matrix.

3. The UE of claim 1, wherein the one or more processors, to receive the indication of the uplink precoder, are configured to receive a quantized indication of the precoder via at least one of a downlink control information (DCI) communication or a medium access control (MAC) control element (MAC-CE).

4. The UE of claim 1, wherein the uplink precoder is associated with a sub-band used to transmit the uplink transmission associated with the uplink MU-MIMO communication.

5. The UE of claim 1, wherein the one or more processors, to receive the indication of the uplink precoder, are configured to receive the indication of the uplink precoder via an uplink precoder report.

6. The UE of claim 5, wherein the uplink precoder report is a periodic uplink precoder report associated with a periodicity.

7. The UE of claim 5, wherein the uplink precoder report is a semi-periodic report associated with at least one of a minimum periodicity or a maximum periodicity, and
wherein the one or more processors, to receive the indication of the uplink precoder via the uplink precoder report, are configured to receive the uplink precoder report a time period after a previously transmitted uplink precoder report that is greater than or equal to the minimum periodicity and less than or equal to the maximum periodicity.

8. The UE of claim 7, wherein the one or more processors, to receive the indication of the uplink precoder via the uplink precoder report, are configured to receive the uplink precoder report via at least one of:
a message in which the uplink precoder report is transmitted in combination with one of a physical downlink control channel communication or a physical downlink shared channel communication, or
a standalone uplink precoder report message.

9. The UE of claim 1, wherein the uplink precoder is a codebook-based uplink precoder, and
wherein the one or more processors, to receive the indication of the uplink precoder, are configured to receive an indication of an index that corresponds to the uplink precoder in an uplink precoder codebook.

10. The UE of claim 1, wherein the uplink MU-MIMO communication is associated with a block diagonal geometric mean decomposition operation associated with a network node.

11. A network node, comprising:
one or more memories; and
one or more processors coupled to the one or more memories, the one or more processors individually or collectively configured to:
transmit, to a user equipment (UE), an indication of an uplink precoder for an uplink multi-user multiple input multiple output (MU-MIMO) communication that is associated with the UE and one or more other UEs; and
receive, from the UE, an uplink transmission associated with the uplink MU-MIMO communication that is based at least in part on the uplink precoder.

12. The network node of claim 11, wherein the uplink precoder is associated with a unitary matrix.

13. The network node of claim 11, wherein the one or more processors, to transmit the indication of the uplink precoder, are configured to transmit the indication of the uplink precoder via an uplink precoder report.

14. The network node of claim 13, wherein the uplink precoder report is a periodic uplink precoder report associated with a periodicity.

15. The network node of claim 13, wherein the uplink precoder report is a semi-periodic report associated with at least one of a minimum periodicity or a maximum periodicity, and
wherein the one or more processors, to transmit the indication of the uplink precoder via the uplink precoder report, are configured to transmit the uplink precoder report a time period after a previously transmitted uplink precoder report that is greater than or equal to the minimum periodicity and less than or equal to the maximum periodicity.

16. The network node of claim 13, wherein the one or more processors, to transmit the indication of the uplink precoder via the uplink precoder report, are configured to transmit the uplink precoder report based at least in part on at least one of:
a switch of a reception beam associated with the network node, or
a change in an uplink channel associated with the network node.

17. The network node of claim 11, wherein the uplink MU-MIMO communication is associated with a block diagonal geometric mean decomposition operation associated with the network node.

18. A method of wireless communication performed by a user equipment (UE), comprising:
receiving an indication of an uplink precoder for an uplink multi-user multiple input multiple output (MU-MIMO) communication that is associated with the UE and one or more other UEs; and
transmitting an uplink transmission associated with the uplink MU-MIMO communication based at least in part on using the uplink precoder.

19. The method of claim 18, wherein receiving the indication of the uplink precoder includes receiving the indication of the uplink precoder via an uplink precoder report.

20. The method of claim 18, wherein the uplink MU-MIMO communication is associated with a block diagonal geometric mean decomposition operation associated with a network node.
